(19) United States
(12) Patent Application Publication
(10) Pub. No.: US 2019/0067735 A1
(43) Pub. Date: Feb. 28, 2019

(54) LITHIUM ION SECONDARY BATTERY

(71) Applicant: Murata Manufacturing Co., Ltd., Nagaokakyo-shi (JP)

(72) Inventor: Masato Fujioka, Nagaokakyo-shi (JP)

(21) Appl. No.: 16/171,658

(22) Filed: Oct. 26, 2018

Related U.S. Application Data
(63) Continuation of application No. PCT/JP2017/021346, filed on Jun. 8, 2017.

(30) Foreign Application Priority Data
Jun. 13, 2016 (JP) 2016-117079

(51) Int. Cl. H01M 10/0525; H01M 4/58; H01M 2/02; H01M 2/06; H01M 4/62; H01M 10/0585

(52) U.S. Cl. CPC H01M 10/0525; H01M 4/5825; H01M 2/0275; H01M 2004/028; H01M 4/624; H01M 10/0585; H01M 2/06

(57) ABSTRACT

A lithium ion secondary battery that includes a positive electrode having a positive electrode mixture layer containing a positive electrode active material using a lithium-containing metal phosphate compound having an olivine structure and a conductive aid in a particulate form. Moreover, a negative electrode has a negative electrode mixture layer with a separator interposed between the positive and negative electrodes. The thickness of the positive electrode mixture layer is 75 μm or less. Furthermore, the positive electrode active material is formed from secondary particles having a diameter of 10 or less, with the secondary particles being formed by flocculating multiple primary particles having a particle size of 1 μm or less. The conductive aid has one or more constituent particles contained within a range of 5 μm from a center of the primary particle.

### CROSS REFERENCE TO RELATED APPLICATIONS

The present application is a continuation of PCT/JP2017/021346 filed Jun. 8, 2017, which claims priority to Japanese Patent Application No. 2016-117079, filed Jun. 13, 2016, the entire contents of each of which are incorporated herein by reference.

### TECHNICAL FIELD

The present disclosure relates to a lithium ion secondary battery.

### BACKGROUND

Lithium ion secondary batteries are widely popular as batteries used for portable electronic equipment such as cellular phones, laptop computers, electric vehicles, hybrid vehicles, and the like.

A lithium-containing metal phosphate compound having an olivine structure is currently used as a positive electrode active material for lithium ion secondary batteries. When the lithium-containing metal phosphate compound having an olivine structure is used as a positive electrode active material, it is known that pulverization of particles of the active material increases reaction areas and formation of carbonaceous film on surfaces of primary particles improves conductivity.

However, when a positive electrode is manufactured using the pulverized positive electrode active material, a binder is likely to run out because of the large specific surface area of the positive electrode active material, which may deteriorate binding properties between the positive electrode active materials and between a positive electrode active material and a current collector. Therefore, it has been proposed to flocculate the primary particles of the pulverized positive electrode active material into secondary particles to thereby reduce the specific surface area of the positive electrode active material.

Patent Document 1 (identified below) discloses a lithium ion secondary battery capable of securing both electronic conductivity with a small amount of binder and binding properties between the positive electrode active materials and between a positive electrode active material and a current collector, by forming a positive electrode using as the positive electrode active material, secondary particles having predetermined average micropores with the secondary particles formed by flocculating primary particles with carbonaceous films formed thereon, and also using a binder having a predetermined molecular weight.

Patent Document 1: Japanese Patent Application Laid-Open No. 2015-69822.

However, when the secondary particles formed by flocculating the plurality of primary particles are used as the positive electrode active material, the particles increase in size, which causes difficulty in thinly layering the electrode. Therefore, it is difficult to adopt a technique in which the thinly layered electrode reduces the lithium ion transfer resistance in order to achieve higher output of the battery. Further, since no conductive aid particle is present inside the secondary particles, the electronic conductivity decreases, thus making it difficult for the battery to produce higher output.

### SUMMARY OF THE INVENTION

The present disclosure addresses the problems mentioned above with respect to conventional designs. Thus, an object of the disclosure is to provide a lithium ion secondary battery that includes a positive electrode containing a positive electrode active material made of secondary particles formed by flocculating primary particles, and is configured to produce higher output.

As disclosed herein, the lithium ion secondary battery of the present embodiment includes a positive electrode having a positive electrode mixture layer containing a positive electrode active material using a lithium-containing metal phosphate compound having an olivine structure and a conductive aid in a particulate form. Moreover, the exemplary lithium ion secondary battery includes a negative electrode having a negative electrode mixture layer, a separator interposed between the positive electrode and the negative electrode, and a nonaqueous electrolyte. Preferably, a thickness of the positive electrode mixture layer is 75 μm or less, the positive electrode active material is made of secondary particles having a diameter of 10 μm or less formed by flocculating a plurality of primary particles having a particle size of 1 μm or less, and at least one constituent particle of the conductive aid is contained within a range of 5 μm from a center of the primary particle.

In one exemplary aspect, the thickness of the positive electrode mixture layer may be 50 μm or less.

In another exemplary aspect, at least one constituent particle of the conductive aid may be contained within a range of 2.5 μm from a center of the primary particle.

According to the exemplary embodiments of the present disclosure, the positive electrode active material does not contain a secondary particle having a diameter of more than 10 μm. The configuration enables the electrode to be thinly layered. Moreover, this configuration reduces the lithium ion transfer resistance, thus making it possible for the battery to achieve higher output. In addition, at least one constituent particle of the conductive aid is contained within a range of 5 μm from the center of the primary particle, so that electronic resistance in the positive electrode mixture layer can be reduced, thus making it possible for the battery to achieve higher output.

### BRIEF DESCRIPTION OF DRAWINGS

FIG. 1 is a cross-sectional view of a lithium ion secondary battery according to an embodiment of the present disclosure.

### DETAILED DESCRIPTION

Features of the present disclosure will be described in more detail below with reference to an exemplary embodiment.

Specifically, description will be made below by exemplifying a lithium ion secondary battery having a structure in which a stack and a nonaqueous electrolyte are housed in an outer package. The stack is formed by alternately stacking a plurality of positive electrodes and negative electrodes with separators interposed between the positive electrodes and the negative electrodes.

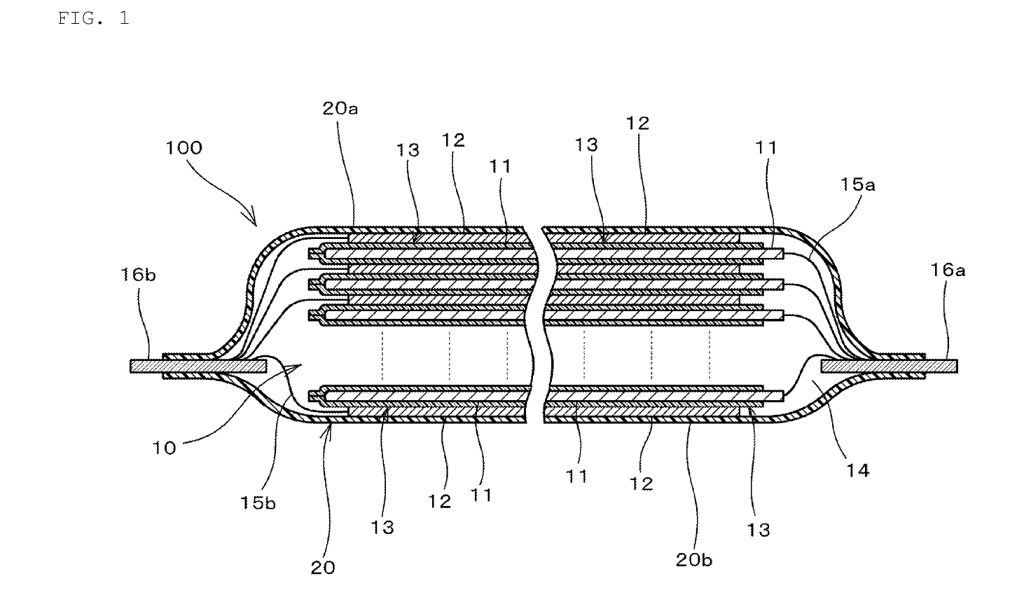

FIG. 1 is a cross-sectional view of a lithium ion secondary battery 100 according to an embodiment of the present invention. As shown, the lithium ion secondary battery 100 has a structure in which a stack 10 and a nonaqueous electrolyte 14 are housed in a laminate case 20. The stack 10 is formed by alternately stacking a plurality of positive electrodes 11 and negative electrodes 12 with separators 13 interposed between the positive electrodes and the negative electrodes.

In an exemplary aspect, the laminate case 20 that is an outer package formed by subjecting peripheral portions of a pair of laminate films 20a and 20b to thermocompression bonding to join them.

As further shown, a positive electrode terminal 16a is led out of one end of the laminate case 20, and a negative electrode terminal 16b is led out of the other end of the laminate case 20. The plurality of positive electrodes 11 are connected to the positive electrode terminal 16a through a lead 15a. The plurality of negative electrodes 12 are connected to the negative electrode terminal 16b through a lead 15b.

The negative electrode 12 has a negative electrode mixture layer. More specifically, the negative electrode 12 is formed by coating the negative electrode mixture layer on both sides of a negative current collector. The negative electrode mixture layer contains, for example, a negative electrode active material, a binder, and a conductive aid. Examples of the negative current collector that may be used include metal foils such as copper. It is noted that the exemplary embodiment is not limited to the structure or material of the negative electrode 12.

The positive electrode 11 has a positive electrode mixture layer containing a positive electrode active material using a lithium-containing metal phosphate compound having an olivine structure, and a conductive aid in a particulate form. More specifically, the positive electrode 11 is formed by coating the positive electrode mixture layer on both sides of a positive current collector. The positive electrode mixture layer may contain a binder, in addition to the positive electrode active material and the conductive aid.

In an exemplary aspect, examples of the lithium-containing metal phosphate compound having an olivine structure that may be used include lithium iron phosphate, lithium manganese phosphate, and the like.

The thickness of the positive electrode mixture layer is 75 μm or less. For purposes of this disclosure, the term “thickness of the positive electrode mixture layer” herein refers to the dimension of the positive electrode mixture layer in a stacking direction of the positive electrodes 11, the separators 13, and the negative electrodes 12. Moreover, the term “thickness of the positive electrode mixture layer” herein also refers to the thickness of the positive electrode mixture layer formed on each side of the positive current collector.

The positive electrode active material include a lithium-containing metal phosphate compound having an olivine structure is made of a plurality of secondary particles having a diameter of 10 μm or less formed by flocculating a plurality of primary particles having a particle size of 1 μm or less. That is, the positive electrode active material does not contain secondary particles having a diameter of more than 10 μm according to the exemplary embodiment. When the diameter of each of the secondary particles in the positive electrode active material is 10 μm or less, the positive electrode 11 can be thinly layered, which reduces the lithium ion transfer resistance, and thus enable the lithium ion secondary battery 100 to produce higher output.

The secondary particles, which form the positive electrode active material, can be granulated by flocculating the plurality of primary particles so as to have a diameter of 10 μm or less, or may be crumbled into small particles having a diameter of 10 μm or less after granulation of the secondary particles including some having a diameter of 10 μm or more.

According to the exemplary embodiment, at least one constituent particle of the conductive aid is contained within the range of 5 μm from the center of the primary particle of the positive electrode active material. That is, the constituent particle is preferably within a 5 μm radius about the center of the primary particle of the positive electrode active material. This configuration uniformly reduces electronic resistance in the positive electrode mixture layer, thus making it possible for the lithium ion secondary battery 100 to produce higher output. The material forming the conductive aid is not particularly limited, and, for example, acetylene black can be used.

It is further noted that the separator 13 can be any structure suitably configured for the lithium ion secondary battery. For example, the separator 13 as shown in FIG. 1 has a bag shape, but can have a sheet shape or a zigzag shape.

It is noted that the nonaqueous electrolyte 14 is also not particularly limited as long as it is suitable for the lithium ion secondary battery. Thus, various known nonaqueous electrolytic solutions can be used, for example. As the nonaqueous electrolyte 14, a solid electrolyte may also be used.

### EXAMPLES

To prepare the positive electrode 11, first, granules of secondary particles of lithium iron phosphate (LFP), acetylene black, and polyvinylidene fluoride (PVdF) were prepared as a positive electrode active material, a conductive aid, and a binder, respectively, and then dispersed in N-methyl-2-pyrrolidone (NMP) so that the weight ratio of LFP:acetylene black:PVdF was 80:12:8, to thereby prepare a positive electrode slurry. The dispersion conditions were changed during the dispersion, and a plurality of positive electrode slurry in which the secondary particles of LFP have different particle sizes were prepared.

Subsequently, the positive electrode slurry thus prepared was applied to both sides of an aluminum foil using a die coater so that the one-side basis weight of the applied slurry was set to a predetermined value of 4.5 mg/cm² or more and 18.0 mg/cm² or less, and dried. Thereafter, the dried layer was press-consolidated using a roll press machine so as to have a porosity of 40%, and then cut into a predetermined shape, to thereby prepare a positive electrode plate.

For preparation of the negative electrode 12, natural graphite and PvdF were prepared as a negative electrode active material and a binder, respectively, and dispersed in N-methyl-2-pyrrolidone (NMP) so that the weight ratio of natural graphite:PVdF was 93:7, to thereby prepare a negative electrode slurry.

Subsequently, the negative electrode slurry thus prepared was applied to both sides of a copper foil using a die coater so that the one-side basis weight of the applied slurry had a ratio of the negative electrode capacity to the positive electrode capacity (A/C ratio) of 1.3, and dried. Thereafter, the dried layer was press-consolidated using a roll press machine so as to have a porosity of 40%, and then cut into a predetermined shape, to thereby prepare a negative electrode plate.

Then, the plurality of positive electrode plates and negative electrode plates prepared were alternately stacked with separators interposed therebetween. All the positive electrode plates were welded to positive electrode tabs and all the negative electrode plates were welded to negative electrode tabs, and the welded plates were placed in an aluminum laminate cup. Into the aluminum laminate cup was injected an organic electrolytic solution which was obtained by dissolving 1 mol of lithium hexafluorophosphate (LiPF₆) in 1 liter of a solvent mixing ethylene carbonate (EC) and ethylmethyl carbonate (EMC) at a volume ratio of 25:75. The aluminum laminate cup was temporarily vacuum-sealed, and then charged and discharged at 0.2 CA. A gas generated by the charge/discharge was released out of the aluminum laminate cup, and thereafter, the aluminum laminate cup was fully vacuum-sealed, to thereby prepare a cell having a capacity of 100 mAh. The prepared cell was fully charged and subjected to aging treatment at 55° C. for 5 days, to thereby prepare samples (evaluation cells) with sample numbers 1 to 12 as shown in Table 1.

TABLE 1

| | Constitution of positive electrode | | | | | | | |
|---|---|---|---|---|---|---|---|---|
| | One-side | Thickness | Maximum | Conductive | | | | |
| | basis weight | of positive | secondary | aid particle | Evaluation | | | |
| | of positive | electrode | particle | within | | Press- | Output | Electronic |
| Sample | slurry | mixture | size | 5-μm | Coating | stretching | DCR | resistance |
| No. | (mg/cm²) | layer (μm) | (μm) | radius | streaks | ratio (%) | (mΩ) | (mΩ) |
| *1 | 4.5 | 25 | 16 | Absence | Presence | 0.15 | 191 | 122 |
| 2 | 4.5 | 25 | 10 | Presence | Absence | 0.07 | 142 | 56 |
| 3 | 4.5 | 25 | 4 | Presence | Absence | 0.05 | 109 | 29 |
| *4 | 9.0 | 50 | 16 | Absence | Presence | 0.18 | 204 | 151 |
| 5 | 9.0 | 50 | 10 | Presence | Absence | 0.09 | 146 | 65 |
| 6 | 9.0 | 50 | 4 | Presence | Absence | 0.07 | 123 | 43 |
| *7 | 13.8 | 75 | 16 | Absence | Absence | 0.25 | 226 | 177 |
| 8 | 13.8 | 75 | 10 | Presence | Absence | 0.10 | 150 | 71 |
| 9 | 13.8 | 75 | 4 | Presence | Absence | 0.09 | 142 | 50 |
| *10 | 18.0 | 100 | 16 | Absence | Absence | 0.33 | 254 | 192 |
| *11 | 18.0 | 100 | 10 | Presence | Absence | 0.20 | 192 | 75 |
| *12 | 18.0 | 100 | 4 | Presence | Absence | 0.10 | 171 | 64 |

[Evaluation Method]

In order to evaluate the evaluation cells, presence/absence of occurrence of coating streaks; press-stretching ratio; maximum secondary particle size; presence/absence of a constituent particle of the conductive aid within a range of 5 μm from the center of the primary particle, that is, within a 5 μm radius about the center of the primary particle of the positive electrode active material; direct-current resistance at the output (hereinafter referred to as output DCR); and electronic resistance were examined as described later.

(Evaluation of Electrode)

Presence/absence of occurrence of coating streaks during coating of positive electrode slurry

Undesired coating streaks occurred during coating of the positive electrode slurry using a die coater caused deterioration in yield, and therefore, the presence/absence of the occurrence of coating streaks during the coating of the positive electrode slurry was visually confirmed. The presence/absence of the occurrence of coating streaks may be confirmed in an optical method.

2. Press-Stretching Ratio

In the course of preparing the positive electrode plate, when the aluminum foil of the current collector is stretched upon pressing using a roll press machine, the positive electrode 11 is deformed, and thus causing deterioration in yield in the following slitting or cutting step and the stacking step. Therefore, the stretching ratio of the aluminum foil upon pressing in the step of preparing the positive electrode plate was obtained as a press-stretching ratio. When the press-stretching ratio was 0.1% or less, it was judged as a level at which the positive electrode plate has no problem as a product.

3. Maximum Secondary Particle Size

A cross section of the positive electrode 11 was exposed by a known ion milling treatment, an image of the cross section of the positive electrode 11 obtained using a scanning electron microscope (SEM) was analyzed, to thereby determine the maximum particle size of the secondary particles of the positive electrode active material in the positive electrode mixture layer as a maximum secondary particle size.

4. Presence/Absence of Conductive Aid Particle within a Range of 5 μm from the Center of the Primary Particle

A cross section of the positive electrode 11 was exposed by a known ion milling treatment, an image of the cross section of the positive electrode 11 obtained using a scanning electron microscope (SEM) was analyzed, to thereby confirm whether or not at least one constituent particle of the conductive aid was contained within a range of 5 μm from the center of each of the primary particles of LFP in the positive electrode mixture layer.

(Evaluation of Cells)

Output DCR

Each cell was discharged from 5% SOC at currents of 1 CA, 3 CA, 5 CA, 10 CA, and 20 CA for 10 seconds, and the voltage thereat was determined. Then, the data thus obtained were plotted with the current values as abscissa and the voltage values as ordinate, to thereby obtain the slope of the plotted line as output DCR. Here, whether or not the obtained output DCR was a target value of a high output cell of 150 mΩ or less was confirmed.

2. Electronic Resistance

Alternating-current resistance was measured at 1 kHz and 50% SOC at room temperature (25° C.) using an impedance analyzer, to obtain an electronic resistance. Here, it was confirmed whether the obtained electronic resistance was a target value of a high output cell of 75 mΩ or less.

As shown above, Table 1 illustrates one-side basis weight (mg/cm²) of the positive electrode slurry, thickness (μm) of the positive electrode mixture layer, maximum secondary particle size (μm), presence/absence of conductive aid particle within a range of 5 μm from the center of the primary particle, presence/absence of coating streaks, press-stretching ratio (%), output DCR (mΩ), and electronic resistance (me), for the samples with sample numbers 1 to 12.

In Table 1, the evaluation cells with sample numbers indicated by a “*” are samples not satisfying the requirements of the present invention that a thickness of the positive electrode mixture layer is 75 μm or less, the positive electrode active material is made of secondary particles having a diameter of 10 μm or less formed by flocculating a plurality of primary particles having a particle size of 1 μm or less, and at least one constituent particle of the conductive aid is contained within a range of 5 μm from a center of the primary particle. Moreover, those sample number that are not indicated by a “*” are samples satisfying the requirements of the present invention.

All of the evaluation cells with sample numbers 2, 3, 5, 6, 8, and 9 satisfying the requirements of the present invention had an output DCR of 150 mΩ or less and an electronic resistance of 75 mΩ or less. Therefore, the resistance of the battery is reduced, thereby achieving higher output. In addition, in these evaluation cells, coating streaks did not occur, and the press-stretching ratio was 0.1% or less, thus resulting in improvement in yield.

The evaluation cells with sample numbers 1 and 4 are samples not satisfying the requirements of the present invention, in which the diameter of the secondary particle is larger than 10 μm and the constituent particle of the conductive aid is not contained within a range of 5 μm from the center of the primary particle. These evaluation cells with sample numbers 1 and 4 had an output DCR higher than 150 mΩ and an electronic resistance higher than 75 mΩ. In addition, in both of the evaluation cells, coating streaks occurred, and the press-stretching ratio was higher than 0.1%.

The evaluation cell with sample number 7 is a sample not satisfying the requirements of the present invention, in which the diameter of the secondary particle is larger than 10 μm and the constituent particle of the conductive aid is not contained within a range of 5 μm from the center of the primary particle. This evaluation cell with sample number 7 had an output DCR higher than 150 mΩ and an electronic resistance higher than 75 mΩ. In addition, coating streaks did not occur, but the press-stretching ratio was higher than 0.1%.

The evaluation cell with sample number 10 is a sample not satisfying the requirements of the present invention, in which the thickness of the positive electrode mixture layer is more than 75 μm, the diameter of the secondary particle is larger than 10 μm, and the constituent particle of the conductive aid is not contained within a range of 5 μm from the center of the primary particle. This evaluation cell with sample number 10 had an output DCR higher than 150 mΩ and an electronic resistance higher than 75 mΩ. In addition, coating streaks did not occur, but the press-stretching ratio was higher than 0.1%.

The evaluation cell with sample number 11 is a sample not satisfying the requirements of the present invention, in which the thickness of the positive electrode mixture layer is more than 75 μm. This evaluation cell with sample number 11 had an output DCR higher than 150 mΩ. The electronic resistance was 75 mΩ, which was equal to the target value, and coating streaks did not occur. In addition, the press-stretching ratio was higher than a reference value.

The evaluation cell with sample number 12 is a sample not satisfying the requirements of the present invention, in which the thickness of the positive electrode mixture layer is more than 75 μm. This evaluation cell with sample number 12 had an output DCR higher than 150 mΩ. The electronic resistance was lower than the target value, and coating streaks did not occur. In addition, the press-stretching ratio was 0.1%, which was equal to the reference value.

The evaluation cells with sample numbers 1 to 3 are samples having the same one-side basis weight of the positive electrode slurry and the same thickness of the positive electrode mixture layer but having different maximum secondary particle sizes and different in presence/absence of the constituent particle of the conductive aid within a range of 5 μm from the center of the primary particle. It is seen that the output DCR and the electronic resistance of the evaluation cells with sample numbers 2 and 3 satisfying the requirements of the present invention are significantly reduced as compared with those of the evaluation cell with sample number 1 not satisfying the requirements of the present invention. In addition, the smaller the maximum secondary particle size was, the lower the output DCR and the electronic resistance became.

The evaluation cells with sample numbers 4 to 6 are samples having the same one-side basis weight of the positive electrode slurry and the same thickness of the positive electrode mixture layer, but having different maximum secondary particle sizes and different in presence/absence of the constituent particle of the conductive aid within a range of 5 μm from the center of the primary particle. It is seen that the output DCR and the electronic resistance of the evaluation cells with sample numbers 5 and 6 satisfying the requirements of the present invention are significantly reduced as compared with those of the evaluation cell with sample number 4 not satisfying the requirements of the present invention. In addition, the smaller the maximum secondary particle size was, the lower the output DCR and the electronic resistance became.

The evaluation cells with sample numbers 7 to 9 are samples having the same one-side basis weight of the positive electrode slurry and the same thickness of the positive electrode mixture layer but having different maximum secondary particle sizes and different in presence/absence of the constituent particle of the conductive aid within a range of 5 μm from the center of the primary particle. Moreover, it is seen that the output DCR and the electronic resistance of the evaluation cells with sample numbers 8 and 9 satisfying the requirements of the present invention are significantly reduced as compared with those of the evaluation cell with sample number 7 not satisfying the requirements of the present invention. In addition, the smaller the maximum secondary particle size was, the lower the output DCR and the electronic resistance became.

The evaluation cells with sample numbers 2, 5, and 8 are samples having the same maximum secondary particle size and the constituent particle of the conductive aid present within a range of 5 μm from the center of the primary particle, but having different thicknesses of the positive electrode mixture layer. The same applies to the evaluation cells with sample numbers 3, 6, and 9. As a result of comparing these evaluation cells, it is seen that the thinner the positive electrode mixture layer, the lower the output DCR and the electronic resistance.

That is, the lithium ion secondary battery satisfying the requirements of the present invention that the thickness of the positive electrode mixture layer is 75 μm or less, the positive electrode active material is made of secondary particles having a diameter of 10 μm or less formed by flocculating a plurality of primary particles having a particle size of 1 μm or less, and at least one constituent particle of the conductive aid is contained within a range of 5 μm from a center of the primary particle has the output DCR and the electronic resistance reduced, and can achieve higher output. In addition, in the lithium ion secondary battery satisfying the above requirements of the present invention, coating streaks did not occur, and the press-stretching ratio was low, thus resulting in improvement in yield.

In the exemplary embodiment described above, although the thickness of the positive electrode mixture layer is 75 μm or less, the thinner the positive electrode mixture layer, the lower the output DCR and the electronic resistance. Therefore, the positive electrode mixture layer is preferably thinner and preferably has a thickness of, for example, 50 μm or less. Setting of the thickness of the positive electrode mixture layer to 50 μm or less can achieve even higher output of the battery.

When the constituent particle of the conductive aid is contained at a distance close to the center of the primary particle, the electronic conductivity increases. Therefore, it is possible to further increase the electronic conductivity, for example, by containing at least one constituent particle of the conductive aid within a range of 2.5 μm from the center of the primary particle, thus making it possible for the battery to achieve even higher output.

In the exemplary embodiment described above, description has been made by exemplifying the lithium ion secondary battery having the structure in which the stack and the nonaqueous electrolyte are housed in the outer package, the stack being formed by alternately stacking the plurality of positive electrodes and negative electrodes with the separators interposed between the positive electrodes and negative electrodes. However, it should be appreciated that the structure of the lithium ion secondary battery according to the present disclosure is not limited to the above-mentioned structure. For example, the lithium ion secondary battery may have a structure in which a wound body and a nonaqueous electrolyte are housed in the outer package, the wound body being formed by winding the positive electrodes and the negative electrodes stacked with the separators interposed between the positive electrodes and the negative electrodes. The outer package may be a metal can, instead of the laminate case.

It is finally noted that the exemplary embodiments of the present disclosure as described above are not limited to the specific embodiment described above, but various applications and modifications can be made within the scope of the invention as would be appreciated to one skilled in the art.

### DESCRIPTION OF REFERENCE SYMBOLS

10: Stacks

11: Positive electrode

12: Negative electrode

13: Separator

14: Nonaqueous electrolyte

20: Laminate case

100: Lithium ion secondary battery

1. A lithium ion secondary battery comprising:
at least one positive electrode having a positive electrode mixture layer including a positive electrode active material with a lithium-containing metal phosphate compound having an olivine structure and a conductive aid in a particulate form;
at least one negative electrode having a negative electrode mixture layer;
at least one separator interposed between the at least one positive electrode and the at least one negative electrode, respectively; and
a nonaqueous electrolyte,
wherein the positive electrode mixture layer comprises a thickness of 75 μm or less and includes a plurality of secondary particles each having a diameter of 10 μm or less,
wherein the secondary particles are formed by a plurality of flocculated primary particles each having a particle size of 1 μm or less, and
wherein the conductive aid includes at least one constituent particle that is disposed within 5 μm from a center of at least one of the primary particles, respectively.

2. The lithium ion secondary battery according to claim 1, wherein the thickness of the positive electrode mixture layer is 50 μm or less.

3. The lithium ion secondary battery according to claim 1, wherein the at least one constituent particle of the conductive aid is disposed within a range of 2.5 μm from the center of the at least one primary particle.

4. The lithium ion secondary battery according to claim 1, further comprising a plurality of positive electrodes each including the positive electrode mixture layer and a plurality of negative electrodes each including the negative electrode mixture layer, with a plurality of separators interposed therebetween, respectively, to form a stack configuration.

5. The lithium ion secondary battery according to claim 4, further comprising a laminate case configured to house the stack configuration and the nonaqueous electrolyte.

6. The lithium ion secondary battery according to claim 5, further comprising a positive electrode terminal extending outside the laminate case on a first side thereof and electrically coupled to the plurality of positive electrodes and a negative electrode terminal extending outside the laminate case on a second side thereof and electrically coupled to the plurality of negative electrodes.

7. The lithium ion secondary battery according to claim 4, wherein the thickness of the positive electrode mixture layer extends in a stacking direction of the stacking configuration.

8. The lithium ion secondary battery according to claim 1, wherein the lithium-containing metal phosphate compound comprises one of a lithium iron phosphate and a lithium manganese phosphate.

9. The lithium ion secondary battery according to claim 1, wherein the conductive aid comprises acetylene black.

10. The lithium ion secondary battery according to claim 1, wherein the at least one separator comprises one of a bag shape, a sheet shape or a zigzag shape.

11. A lithium ion secondary battery comprising:
at least one positive electrode including a positive electrode mixture layer having a thickness of 75 μm or less and formed from a plurality of secondary particles each having a diameter of 10 μm or less,
at least one negative electrode having a negative electrode mixture layer; and
at least one separator interposed between the at least one positive electrode and the at least one negative electrode, respectively,
wherein the secondary particles are formed from a plurality of flocculated primary particles each having a particle size of 1 μm or less.

12. The lithium ion secondary battery according to claim 11, wherein the positive electrode mixture layer comprises a positive electrode active material with a lithium-containing metal phosphate compound having an olivine structure and a conductive aid in a particulate form.

13. The lithium ion secondary battery according to claim 12, wherein the conductive aid includes at least one constituent particle that is disposed within 5 μm from a center of at least one of the primary particles, respectively.

14. The lithium ion secondary battery according to claim 11, wherein the thickness of the positive electrode mixture layer is 50 μm or less.

15. The lithium ion secondary battery according to claim 13, wherein the at least one constituent particle of the conductive aid is disposed within a range of 2.5 μm from the center of the primary particle.

16. The lithium ion secondary battery according to claim 11, further comprising a plurality of positive electrodes each including the positive electrode mixture layer and a plurality of negative electrodes each including the negative electrode mixture layer, with a plurality of separators interposed therebetween, respectively, to form a stack configuration.

17. The lithium ion secondary battery according to claim 16, further comprising a laminate case configured to house the stack configuration and the nonaqueous electrolyte.

18. The lithium ion secondary battery according to claim 17, further comprising a positive electrode terminal extending outside the laminate case on a first side thereof and electrically coupled to the plurality of positive electrodes and a negative electrode terminal extending outside the laminate case on a second side thereof and electrically coupled to the plurality of negative electrodes.

19. The lithium ion secondary battery according to claim 16, wherein the thickness of the positive electrode mixture layer extends in a stacking direction of the stacking configuration.

20. The lithium ion secondary battery according to claim 11, wherein the at least one separator comprises one of a bag shape, a sheet shape or a zigzag shape.
